(19) United States
(12) Patent Application Publication
(10) Pub. No.: US 2002/0047929 A1
(43) Pub. Date: Apr. 25, 2002

(54) OSD NOISE REDUCTION SYSTEM AND METHOD

(76) Inventors: HAREL WHEITZ, SAN DIEGO, CA (US); MASANOBU KIMOTO, SAN DIEGO, CA (US)

Correspondence Address: Crosby Heafey Roach & May, Attention Doyle B Johnson, Two Embarcadero Center Suite 2000, P O Box 7936, San Francisco, CA, 94120-7936, US

(21) Appl. No.: 09/190,633

(22) Filed: Nov. 12, 1998

(51) Int. Cl. H04N 5/50

(52) U.S. Cl. 348/569

(57) ABSTRACT

An OSD including a display device for displaying and storing OSD data sets is set forth. The OSD includes an alignment system, associated with the display device. The alignment system aligns a first OSD data set with a second OSD data set. Aligning the OSD data sets reduces noise from the display device when the second OSD data set replaces the first OSD data set on the display system. A method of reducing noise in an OSD, including a memory device having memory cells for storing data, is also set forth. The method reduces noise in updating the OSD. The method includes the following steps. First, a no operation (NOP) code is stored in the memory cells where no change in data is required to update the OSD. Next, the OSD is updated by storing updated data in the memory cells where a data change is required to update the OSD.

### CROSS-REFERENCE TO RELATED APPLICATIONS

None

### STATEMENT AS TO RIGHTS TO INVENTIONS MADE UNDER FEDERALLY-SPONSORED RESEARCH AND DEVELOPMENT

None

1. Field of the Invention

The invention relates generally to embedded software for a display screen. In particular, the invention relates to reducing noise from an on screen display (OSD) of the display screen.

2. Description of Related Art

It is known to provide an OSD of information, such as text or graphics, to a display screen. The display screen can include, for example, a computer monitor, television screen, or any other suitable display screen.

Numerous examples of information displayed by such configurations are known. For example, most television enthusiasts are familiar with a numerical channel indicator display on a television screen prompted by a quick flick of a remote control. It is also known to provide a “picture in a picture” simultaneous display of two television channels. Further, computer programmers and “newbies” alike have encountered the dreaded graphic that pops up onto the screen to inform the user that a computer has crashed. Videographers worldwide have witnessed the date and time glowing in a corner of the screen when viewing their work in progress.

Thus, a variety of configurations are known that provide data sets affecting the information displayed with, or the graphics displayed by an OSD. The quality of the image presented by the OSD is affected by many factors. For example, if the data presented on the OSD is not aligned, then noise can be seen in the image presented by the OSD.

Sometimes the data presented on the display screen is not aligned because of hardware limitations. For example, a hardware limitation exists where the OSD data is selectively stored in a RAM. It is typical for RAMs in such applications to be configured such that individual data strings are stored in memory cells, which are in turn arranged in a series of rows. As the information to be displayed changes, the data sets within these rows are updated, that is, new data strings replace earlier data strings assigned to respective memory cells. This process works fine if there is a one-to-one correspondence between the numbers of new data strings and earlier data strings. However, where less than all of the data strings of a row are updated, as often occurs when updating display data, then “leftover” data from a previous data string remains in the non-updated cells. This leftover data will often appear as noise on the display screen, prompting consumer complaints due to apparently defective displays. Since the noise is not due to any real defect in the display screen, routine tests reveal that the system is operating as it should be, thus adding to consumer and technician frustration.

It can thus be seen that the need exists for a method and apparatus that will reduce this source of noise and the consumer dissatisfaction that results.

### SUMMARY

An OSD including a display device for displaying and storing OSD data sets is set forth. The OSD includes an alignment system associated with the display device. The alignment system aligns a first OSD data set with a second OSD data set. Aligning the OSD data sets reduces noise from the display device when the second OSD data set replaces the first OSD data set on the display system.

A method of reducing noise in an OSD, including a memory device having memory cells for storing data, is also set forth. The method reduces noise in updating the OSD. The method includes the following steps. First, a no operation (NOP) code is stored in the memory cells where no change in data is required to update the OSD. Next, the OSD is updated by storing updated data in the memory cells where a data change is required to update the OSD.

The features of the invention believed to be patentable are set forth with particularity in the appended claims. The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 is a diagram of an OSD constructed in accordance with the principles of the present invention.

FIG. 2 is a schematic illustration of a row of memory cells containing a first data code set.

FIG. 3 is a schematic illustration of a row of memory cells containing a second data code set.

FIG. 4 is a schematic illustration of a row of memory cells containing a data code set in accordance with prior art practices.

FIG. 5 is a schematic illustration of a row of memory cells containing a data code set.

FIG. 6 is a schematic illustration of a row of memory cells containing an updated data code set.

FIG. 7 is a schematic illustration of a row of memory cells containing a data code set in accordance with prior art practices.

### DETAILED DESCRIPTION OF PREFERRED EMBODIMENTS

While this invention is susceptible of embodiment in many different forms, there are shown in the drawings, and will herein be described in detail, exemplary embodiments, with the understanding that the present disclosure is to be considered as illustrative of the principles of the invention and not intended to limit the invention to the exemplary embodiments shown and described.

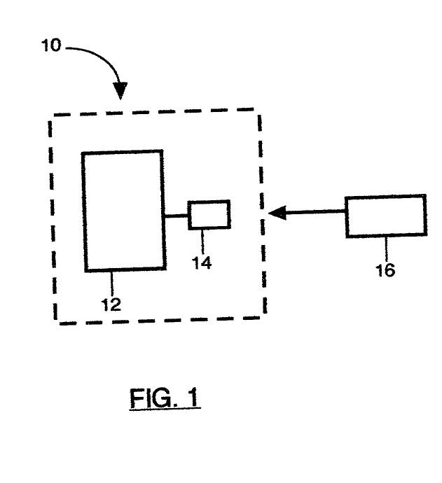

The OSD noise reduction system and method of the present invention reduces noise from an OSD by aligning data presented to the OSD. To this end, a suitable OSD 10 is illustrated generally in FIG. 1. The OSD 10 includes a suitable display screen 12 for displaying on screen data sets and a suitable memory device 14 for storing OSD data sets. The display screen 12 can include any display screen on which an OSD can be presented, such as a television monitor, a screen display for a d-98 display monitor, a computer monitor, a camcorder display, a video monitor, a digital video camera, a palmtop computer screen, or any other display screen. The memory device 14 can include any memory device capable of storing OSD data, such as a RAM or a RAM of an OSD IC. The RAM can include memory cells, each of the memory cells adapted to store a data string of a row of an OSD data set.

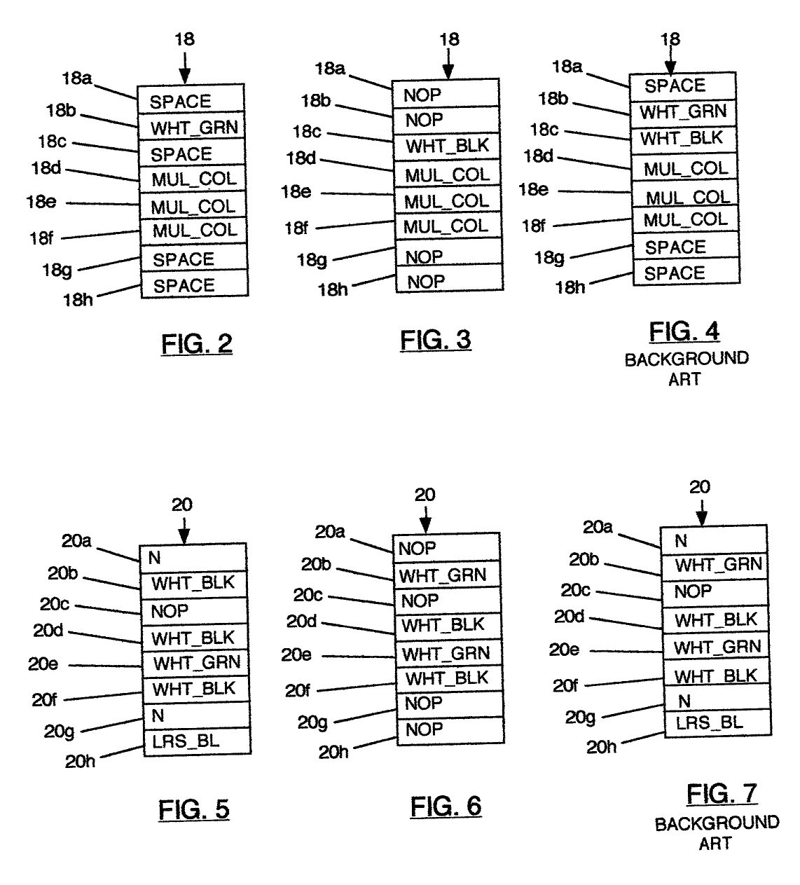

In order to align data stored in the memory device 14, an alignment system 16, associated with the OSD 10 is provided. The alignment system 16 includes a device for feeding sequential display data sets into an input of the memory device 14 of the OSD 10. The alignment system 16 aligns sequential on screen data sets, as will be discussed with reference to FIGS. 2 and 4.

As illustrated in FIG. 2, a first data code set can include a first row 18 of display data. The first row 18 of display data can include display information stored within individual memory cells 18a through 18h, collectively referred to as a data code set. The display information can be provided in the form of data strings, which may contain graphic information, such as the data-strings in memory cells 18a, 18c, 18g, and 18h, color information, such as the data string in cell 18b, or multicolor information, such as the data strings in memory cells 18d, 18e, and 18f. The alignment system 16 can be used to feed the row 18 of display data into the memory device 14, wherein the data strings in memory cells 18a through 18h are stored in individual memory cells of the memory device 14.

In the course of changing the information to be displayed on the display screen 12, at least some of the data in the memory cells 18a-18h in row 18 may be updated with a second data code set, as shown in FIG. 3. The data strings located in cells 18a through 18h shown in FIG. 3 comprise a second, updated data code set, which includes both updated display information, such as data strings in cells 18c through 18f as well as data string fillers, such as data strings 18a, 18b, 18g, and 18h. In the illustrated example, the display update requires changing the data string in cell 18c from “SPACE” to WHT_BLK and maintaining the data strings in cells 18d, 18e, and 18f as “MUL_COL”. In accordance with the present invention, data string “fillers” comprising NOP codes are inserted into the memory cells 18a, 18b, 18g, and 18h to prevent unwanted display information represented by data strings in the first data code set from carrying along with the second, updated data code set.

By contrast, FIG. 4 illustrates row 18 containing a data code set representing what happens in the absence of the present invention. The data strings in cells 18a (“SPACE”), 18b (WHT_GRN”), 18g (“SPACE”), and 18h (“SPACE”) are not replaced with updated information, and thus remain in their memory cells. This leftover data is not necessary to the updated data code set, and may appear as noise on the display screen 12.

With the invention implemented as shown in FIG. 3, the NOP codes align the first data code set with the second data code set in the row 18 of display data within the memory device 14, thereby eliminating leftover data strings as sources of noise from the display 12 of the OSD 10.

Another example implementing the present invention is illustrated in FIGS. 5-7, in which a first data code set is stored in a row 20 of display data. As with row 18, the row 20 of display data can include display information stored within individual memory cells 20a through 20h, collectively referred to as a data code set. The display information can be provided in the form of data strings, which may contain graphic information, such as the data strings in memory cells 20a and 20g, multicolor information, such as the data string in cells 20b, 20d, 20e, and 20f or other display information.

It is contemplated that the present invention is not limited to replacing a first data set with a second, but rather can be practiced with equal efficacy when a second data set is replaced with a third, i.e., at any instance in which data is updated. Row 20 is exemplary of a data set that has already been updated at least once, thus memory cell 20c contains a NOP code which has been carried through previous updates. The alignment system 16 can be used to feed an updated data code set into the row 20, wherein the data strings in memory cells 20a through 20h are stored in individual memory cells of the memory device 14.

In the course of changing the information to be displayed on the display screen 12, at least some of the data in the memory cells 20a-20h in row 20 may be updated with a second data code set, as shown in FIG. 6. The data strings located in cells 20a through 20h shown in FIG. 6 comprise a second, updated data code set, which includes both updated display information, such as data strings in cells 20b, 20d, 20e, and 20f, as well as data string fillers, such as data strings 20a , 20c, 20g, and 20h. In the illustrated example, the display update requires changing the data string in cell 20b from “WHT_BLK” to “WHT_GRN” and maintaining the data strings in cells 20d, 20e, and 20f as “WHT_BLK”, “WHT_GRN”, and “WHT_BLK”, respectively. In accordance with the present invention, data string “fillers” comprising NOP codes are inserted into, or maintained in, the memory cells 20a, 20c, 20g, and 20h to prevent unwanted display information represented by data strings in the first data code set from carrying along with the second, updated data code set.

By contrast, FIG. 7 illustrates row 20 containing a data code set representing what happens in the absence of the present invention. The data strings in cells 20a and 20g (“N”), and that in 20h (“LRS.BLK”) are not replaced with updated information, and thus remain in their memory cells. This leftover data is not necessary to the updated data code set, and may appear as noise on the display screen 12.

With the invention implemented as shown in FIG. 6, the NOP codes align the first data code set with the second data code set in the row 20 of display data within the memory device 14, thereby eliminating leftover data strings as sources of noise from the display 12 of the OSD 10.

Thus, it can be seen that, when displaying different lines (rows) of the OSD, the updated data string codes for display information, individual colors, and multicolors need to be placed at the same location in memory as were previously-required data string codes. If a particular row does not use a display data code, color code, or multicolor code at the same place where the other row is using them, then a no operation (NOP) code needs to be placed instead. This will align the code in the RAM of the OSD IC and will exclude noise or “garbage” which heretofore appeared on screen, typically at the end of a line of information.

While details of the invention are discussed herein with reference to some specific examples of devices to which the principles of the invention can be applied, the applicability of the invention to other devices and equivalent components thereof will become readily apparent to those of skill in the art.

Accordingly, it is intended that all alternatives, modifications, permutations, and variations to the exemplary embodiments can be made without departing from the scope and spirit of the present invention.

We claim:

1. An OSD comprising:
display means for displaying and storing OSD data sets; and
alignment means, associated with the display means, for aligning a first OSD data set with a second OSD data set to reduce noise from the display means when the second OSD data set replaces the first OSD data set on the display means.

2. An OSD as claimed in claim 1, the display means further comprising a RAM having memory cells, wherein each of the OSD data sets is further defined by rows of display information, each of the rows containing data strings, and wherein each memory cell of the memory cells is adapted to store one of the data strings of each of the rows.

3. An OSD as claimed in claim 2, wherein the RAM is located in an OSD IC.

4. An OSD as claimed in claim 1, wherein the display means includes a television monitor.

5. An OSD as claimed in claim 1, wherein the display means includes a computer monitor.

6. An OSD as claimed in claim 1, wherein the display means includes a camcorder display.

7. An OSD as claimed in claim 1, wherein the display means includes a video monitor.

8. An OSD as claimed in claim 1, wherein the display means includes a digital video camera.

9. An OSD as claimed in claim 1, wherein the display means includes a palmtop computer screen.

10. An OSD as claimed in claim 2, wherein the alignment means is further defined by:
a no operation (NOP) code of one of the data strings of the second OSD data set stored in one of the memory cells, where one of the data strings of the first OSD data set containing display information is replaced within the one of the memory cells by the no operation (NOP) code.

11. An OSD as claimed in claim 2, wherein the alignment means is further defined by:
a no operation (NOP) code of one of the data strings of the second OSD data set stored in one of the memory cells, where one of the data strings of the first OSD data set containing a color code is replaced within the one of the memory cells by the no operation (NOP) code.

12. An OSD as claimed in claim 2, wherein the alignment means is further defined by:
a no operation (NOP) code of one of the data strings of the second OSD data set stored in one of the memory cells, where one of the data strings of the first OSD data set containing a multicolor code is replaced within the one of the memory cells by the no operation (NOP) code.

13. In an OSD system including a memory storage device having a plurality of memory cells arranged in at least one row, each of the memory cells being adapted to selectively store a data code string of a data code set, a method of reducing noise from the OSD system comprising the steps of:
storing a first data code set within the memory cells; and
replacing the first data code set with a second, updated data code set, the second data code set including at least one data code string that replaces a data code string in the first data code set within a predetermined cell;
wherein the step of replacing the first data code set includes the step of inserting a no operation (NOP) code into all memory cells in which there are no data code strings required by the second data code set.

14. A method as claimed in claim 13, further comprising the steps of:
replacing the second data code set with a third, updated data code set, the third data code set including at least one data code string that replaces a data code string in the second data code set within a predetermined cell;
wherein the step of replacing the second data code set includes the step of inserting a no operation (NOP) code into all memory cells in which there are no data code strings required by the third data code set.

15. A method as claimed in claim 14, wherein the steps of replacing the first and second data code sets is further defined by storing the second and third data code sets within memory cells of a RAM.

16. A method as claimed in claim 14, wherein the steps of replacing the first and second data code steps is further defined by storing the second and third data code sets within memory cells of a ram of an OSD IC.

17. A method as claimed in claim 13, wherein the second data code set comprises at least one data string containing display information.

18. A method as claimed in claim 13, wherein the second data code set comprises at least one data string containing a color code.

19. A method as claimed in claim 13, wherein the second data code set comprises at least one data string containing a multicolor code.

20. In an OSD including a memory device having memory cells for storing data, a method of reducing noise in updating the OSD comprising the steps of:
storing a no operation (NOP) code in the memory cells where no change in data is required to update the OSD; and
updating the OSD by storing updated data in the memory cells where a data change is required to update the OSD.
